(19) United States
(12) Patent Application Publication
(10) Pub. No.: US 2026/0014472 A1
(43) Pub. Date: Jan. 15, 2026

(54) STORAGE MEDIUM, INFORMATION PROCESSING SYSTEM, INFORMATION PROCESSING APPARATUS, AND GAME PROCESSING METHOD

(71) Applicant: Nintendo Co., Ltd., Kyoto (JP)

(72) Inventors: Kosuke YABUKI, Kyoto (JP); Tomohiro NAKATANI, Kyoto (JP); Sosuke TAKADA, Kyoto (JP)

(21) Appl. No.: 19/002,565

(22) Filed: Dec. 26, 2024

(30) Foreign Application Priority Data
Jul. 10, 2024 (JP) 2024-110869

(51) Int. Cl. A63F 13/57; A63F 13/803

(52) U.S. Cl. CPC A63F 13/57; A63F 13/803

(57) ABSTRACT

An example information processing system controls a virtual camera to move in a virtual space so as to include a player character in a field of view thereof and to follow the player character from behind. The information processing system sets a first direction for a first object, which is arranged on the field and displayed in a directional display style that is directional in the first direction, wherein the first direction is set in a direction along a direction from the virtual camera to the first object or in a direction along a line-of-sight direction of the virtual camera. In response to contact between the first object and the player character, the information processing system accelerates the player character in a second direction that is along a front direction of the player character.

### CROSS REFERENCE TO RELATED APPLICATION

This application claims priority to Japanese Patent Application No. 2024-110869, filed on Jul. 10, 2024, the entire contents of which are incorporated herein by reference.

### FIELD

The present disclosure relates to a storage medium, an information processing system, an information processing apparatus, and a game processing method for moving a player character on a field in a virtual space.

### BACKGROUND AND SUMMARY

There are conventional game programs for playing games in which moving objects are moved on a game field in a virtual space. In such games, acceleration objects for accelerating moving objects in a predetermined direction are sometimes arranged on the course.

It is desirable that the direction in which the moving object is accelerated by the acceleration object is displayed in a way that is easy for the player to understand.

Thus, the present application discloses a storage medium, an information processing system, an information processing apparatus, and a game processing method that can display the acceleration direction by the acceleration object in a way that is easy for the player to understand.

### 1

An example of one or more non-transitory computer-readable storage medium having stored therein instructions that, when executed, cause one or more processors of an information processing apparatus to execute information processing, the information processing comprising: controlling a player character to move on a field in a virtual space based on an operation input; controlling a virtual camera to move in the virtual space so as to include the player character in a field of view thereof and to follow the player character from behind; setting a first direction for a first object, which is arranged on the field and displayed in a directional display style that is directional in the first direction, wherein the first direction is set in a direction along a direction from the virtual camera to the first object or in a direction along a line-of-sight direction of the virtual camera; and in response to contact between the first object and the player character, accelerating the player character in a second direction that is along a front direction of the player character.

With Configuration (1) above, by setting the first direction to be a direction along a direction from the virtual camera to the first object or to be a direction along the line-of-sight direction of the virtual camera, the second direction in which the player character is accelerated by the first object can be displayed in a way that is easy for the player to understand.

### 2

The information processing may further comprise: in a first mode, setting a movement range along a predetermined route on the field; and moving a plurality of characters, including the player character, in the movement range to thereby realize a race between the plurality of characters.

With Configuration (2) above, the first direction can be set to be a direction along the course without having to set the display style of the first object for each course setting in a race.

### 3

The route may be along a road object arranged on the field. The information processing may comprise: for the first object arranged on the road object, setting, as the first direction, one of a forward direction and a reverse direction along a road that is closer to the line-of-sight direction of the virtual camera.

With Configuration (3) above, with the first object arranged on a road, the direction in which the player character is supposed to travel in a race can be suggested in a way that is easy for the player to understand.

### 4

The information processing may further comprise: in a second mode, controlling the player character to move without setting the movement range along the route.

With Configuration (4) above, in the second mode where the player can move the player character without the limitation of the movement range, it is possible to allow the player recognize that the acceleration direction of the first object is not fixed.

### 5

The information processing may further comprise: in a predetermined period of time specified based on an operation input, arranging the virtual camera at a position in front of the player character in a direction facing the player character; and setting the first direction in a direction along an opposite direction from a line of sight of the virtual camera.

With Configuration (5) above, it is possible to present to the player an image that shows a view behind the player character. Also in that case, the first direction can be set to be a direction along the acceleration direction of the player character.

### 6The directional display style may be based on at least one of an orientation of a texture used in rendering the first object and a scroll direction of the texture.

With Configuration (6) above, it is possible to display the first object in a way that is easy to understand the first direction.

Note that the present specification discloses an example of an information processing apparatus and an information processing system for executing the processing of Configurations (1) to (6). The present specification also discloses a game processing method for executing the processing of Configurations (1) to (6).

With the storage medium, the information processing system, the information processing apparatus, or the game processing method set forth above, it is possible to display the acceleration direction by the acceleration object in a way that is easy for the player to understand.

These and other objectives, features, aspects, and effects will become more apparent from the following detailed description taken in conjunction with the accompanying drawings.

### BRIEF DESCRIPTION OF THE DRAWINGS

FIG. 1 is a diagram showing an example of a non-limiting game system;

FIG. 2 is a block diagram showing an example of an internal configuration of a non-limiting main body apparatus;

FIG. 3 is a diagram showing an example of a field in a virtual space;

FIG. 4 is a diagram showing an example of a base area;

FIG. 5 is a diagram showing an example of a game image when a player character running on a field approaches an acceleration object;

FIG. 6 is a diagram showing an example of a game image when a player character is accelerated by contacting the acceleration object;

FIG. 7 is a diagram showing an example of a method for setting the suggested direction of an acceleration object;

FIG. 8 is a diagram showing an example of the suggested direction of an acceleration object in a situation where a player character is approaching the acceleration object;

FIG. 9 is a diagram showing an example of a game image in a situation where there is a reverse operation input by the player;

FIG. 10 is a diagram showing an example of a storage area that stores various data used in information processes in a non-limiting game system;

FIG. 11 is a flowchart showing an example of the flow of the game process executed by a non-limiting game system; and

FIG. 12 is a sub-flowchart showing an example of the detailed flow of the player character control process of step S5 shown in FIG. 11.

### DETAILED DESCRIPTION OF NON-LIMITING EXAMPLE EMBODIMENTS

### 1. Game System Configuration

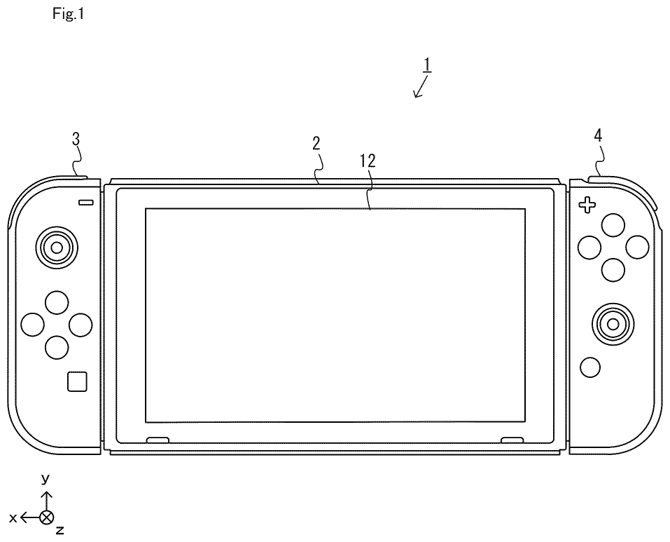

A game system according to an example of an exemplary embodiment is described below. FIG. 1 is a diagram showing an exemplary game system. An example of a game system 1 according to an exemplary embodiment includes a main body apparatus (an information processing apparatus; which functions as a game apparatus main body in an exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

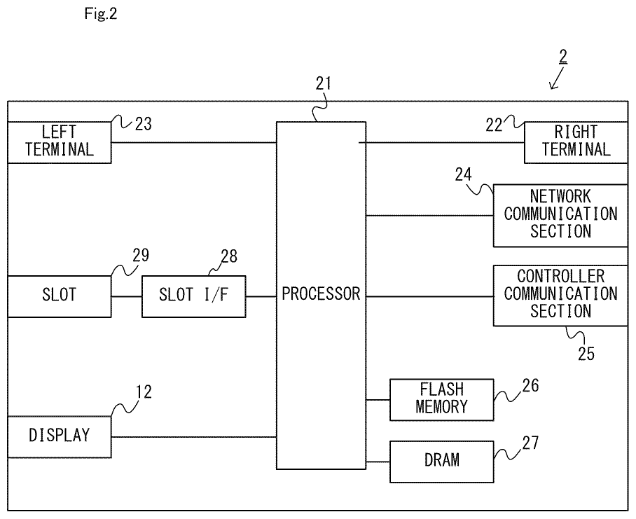

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that a processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In an exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In an exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4 detached from the main body apparatus 2. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, a processor 21 transmits data to the left controller 3 via the left terminal 23 and also receives operation data from the left controller 3 via the left terminal 23. Further, when performing wired communication with the right controller 4, a processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### 2. Game Example in Game System

Next, an example of a game to be executed in the game system 1 will be described. The game of an exemplary embodiment is a game in which a moving object runs on a field in a virtual space (referred to also as game space). In the exemplary embodiment, the player plays the game by controlling a moving object as a player character.

The moving object is an object that moves on the field. For example, the moving object may be an object that moves on land, such as a car, a motorcycle, a bicycle, a horse, or a runner, an object that moves on water or in water, such as a ship, a boat, or a submarine, or an object that moves in the air, such as an airplane, a helicopter, or a glider. The moving object may be a character itself, which imitate a person or an animal, and a game in which the character itself runs or swims may be played.

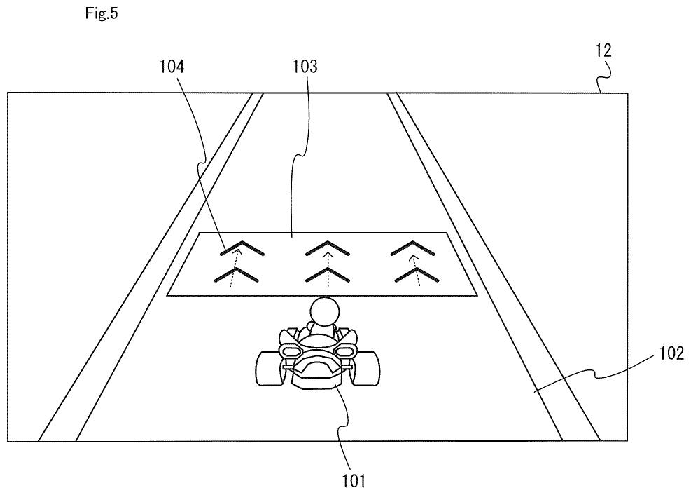

In the exemplary embodiment, the moving object includes a vehicle object and a character object that rides on the vehicle (see FIG. 5). It is assumed in the following description that a game is played using a moving object in which a character rides on a vehicle object that moves on the ground, such as a car. Note however that in other embodiments, the moving object may be only a vehicle object or may be only a character object. In the exemplary embodiment, the moving object moves on the field, but it does not need to be always in contact with the ground, and it may be capable of temporarily flying in the air off the ground.

In the exemplary embodiment, there are a plurality of types of moving objects that differ in shape, size, power, etc., and the player selects the type of moving object to be used as the player character to play the game.

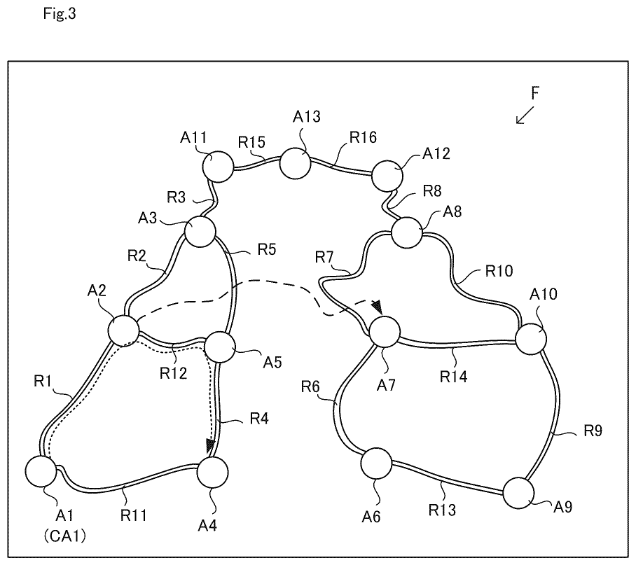

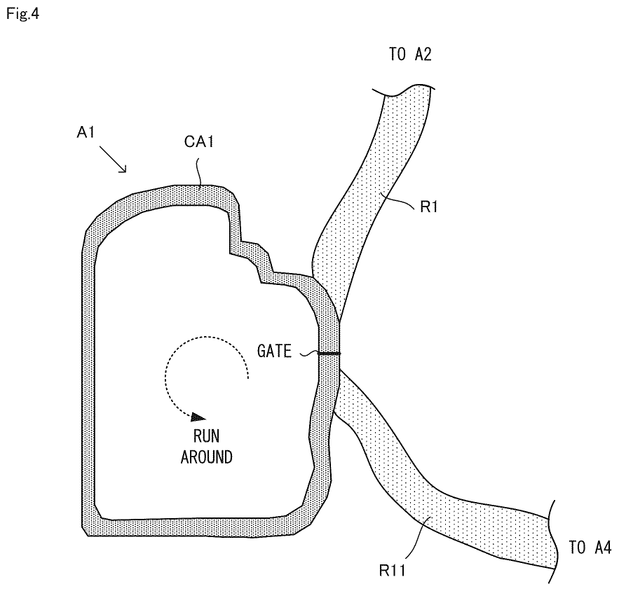

FIG. 3 is a diagram showing an example of a field in a virtual space. As shown in FIG. 3, a plurality of base areas A (A1 to A13 in FIG. 3) are set in the field F in the virtual space. While each base area A is represented by a circle in FIG. 3, each base area A in the field F is an area in which a plurality of moving objects arranged at predetermined positions in the virtual space can race. Each base area A has an intra-base route CA set therein along which moving objects can move. For example, the base area A1 has the intra-base route CA1 set therein that a plurality of moving objects can run around (see FIG. 4). As will be described in more detail later, in a predetermined type of game, players can play a race game in which moving objects run a predetermined number of times around the intra-base route CA set in each base area.

A plurality of base areas are linked together by inter-base routes R (e.g., R1 to R16) where each movable object can move. For example, the base areas A1 and A2 are linked together by the inter-base route R1. The base areas A1 and A4 are linked together by the inter-base route R11.

Hereinafter, an inter-base route R connecting base areas is occasionally referred to simply as a “route R”. An intra-base route CA provided in a base area is occasionally referred to simply as a “route CA”.

FIG. 4 is a diagram showing an example of the base area A1, showing a part of inter-base routes that connect the base area A1 with other base areas. As shown in FIG. 4, the base area A1 has the intra-base route CA1 therein. The intra-base route CA1 is connected to inter-base routes R1 and R11. In the exemplary embodiment, roads are formed along the routes. The roads are continuous through the borders between the intra-base route CA and inter-base routes R.

In the exemplary embodiment, the game is played in two modes using a field as described above. In the first mode, the player character, together with other moving objects, races along a predetermined route on the field. Specifically, the game system 1 sets a movement range along a predetermined route on the field, and allows the player character and other moving objects to race within the movement range.

The movement range may be set as a range that includes a base area and inter-base routes, for example, and a race may be held on a course that includes an intra-base route CA in the base area and the inter-base routes R. Note that a course is a route along which a moving object is supposed to travel in a race game, and is a route extending from the starting point to the goal point. The dotted line in FIG. 3 shows an example of a race course in the first mode. As shown in FIG. 3, a race course in the first mode may include, for example, a plurality of base areas and inter-base routes that connect between the base areas. In the exemplary embodiment, a plurality of race courses are prepared (e.g., a game program includes data for a plurality of race courses), and a race game is played on a course selected in a predetermined manner from among the plurality of courses. The plurality of race courses may include those in which a moving object travels in a predetermined direction along a route, and those in which a moving object travels in the direction opposite to the predetermined direction along the same route.

The movement range does not need to include both a base area and an inter-base route. For example, the movement range may be set as a range that includes a base area, and a race may be held on a course that includes intra-base routes within the base area. For example, the movement range may be set as a range that includes one or more inter-base routes, and a race may be held on a course that includes the inter-base routes.

In the second mode, a game is played in which the player character runs freely around the field. In the second mode, no course is set as in the first mode, and the player can freely move the player character around the field. Note that the broken line in FIG. 3 shows an example of a route of movement of the player character in the second mode. As shown in FIG. 3, in the second mode, the player character can move without following the route, and can, for example, move directly between base areas that are not connected by a route, or even move across a road formed along the route. In the exemplary embodiment, in the first mode, the range in which the player character can move is restricted within the movement range, whereas in the second mode, no such movement range is set.

Note that it may be possible to separately execute the game in the first mode and the game in the second mode. For example, the player may select one of the modes, in response to which the game in that mode is started. It may be possible to consecutively execute the game in the first mode and the game in the second mode. For example, the game in the second mode may start consecutively following the end of the race game in the first mode, so the player character, which has finished the race game in the first mode, is allowed to freely run around the field. For example, during the game in the second mode, a race game in the first mode may be started in response to satisfaction of a predetermined condition. The predetermined condition may be, for example, that the player perform a predetermined operation input, or that the in-game time or the real time reach a predetermined time.

In each mode of the game, the player character is controlled to move based on the operation input by the player. For example, the game system 1 changes the moving direction of the player character in response to a directional input by the player, and changes the speed of the player character in response to an acceleration or deceleration operation input by the player. Note that the operations related to the player character are not limited to the above, but other operation inputs may also be allowed. For example, the player may be allowed to make an operation input that causes the player character to use an item. Note that in the exemplary embodiment, in addition to the operations related to the player character, the player may also make an operation input related to the virtual camera (details will be described later).

The game system 1 controls the movement of the virtual camera in the virtual space so as to generate a game image including the player character. In the exemplary embodiment, the virtual camera is controlled to move in the virtual space so as to include the player character in the field of view thereof and to follow the player character from behind. Thus, a game image showing the field as the player character is viewed from behind is generated and displayed (see FIG. 5). For example, the position of the virtual camera is controlled so that the virtual camera is at a reference position for viewing the player character from behind, based on the position and orientation of the player character. Note that the reference position may be, for example, a position that is a predetermined distance behind the position of the player character, or a position that is a predetermined height above the position of the player character in the height direction. The orientation of the virtual camera set at the reference position is set to face the player character from the position of the virtual camera.

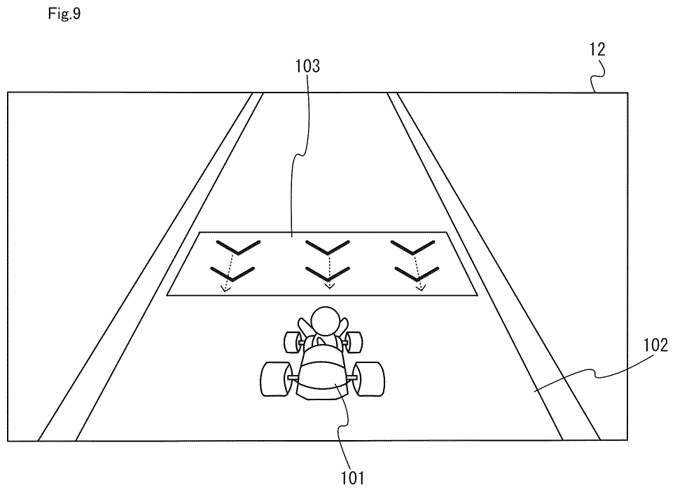

Note that the virtual camera does not always need to be positioned behind the player character. In the exemplary embodiment, the game system 1 changes the position of the virtual camera in response to a camera operation input by the player. Specifically, the virtual camera is controlled so that the virtual camera revolves while maintaining its line-of-sight direction facing the player character in response to a directional input by the player. Thus, the player can move the virtual camera to a position where the virtual camera can see the player character from the side or from the front, etc. In the exemplary embodiment, the game system 1 controls the movement of the virtual camera in response to a reverse operation input by the player. In response to this reverse operation input, the virtual camera is controlled to be in the position and orientation such that the player character is viewed from the front (see FIG. 9). In the exemplary embodiment, the virtual camera is in the position and orientation as described above for a period of time as specified based on the reverse operation input. Note that this period of time is, for example, the period of time during which the button for the reverse operation input is pressed. Note that in other embodiments, the period of time may be, for example, the period from when the button for the reverse operation input is pressed until the next time the button is pressed after the button is released.

Note that after the camera operation input or the reverse operation input is completed, the virtual camera gradually moves to the reference position described above as a result of being controlled so as to include the player character in the field of view and to follow the player character from behind.

Note that in other embodiments, the virtual camera may be controlled to provide a so-called first-person view, and game images not including the player character therein may be generated.

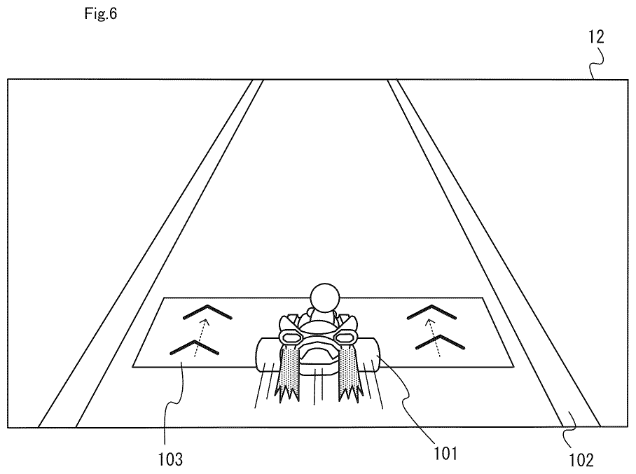

Next, acceleration objects that are provided on the field will be described. FIG. 5 is a diagram showing an example of a game image when the player character running on the field approaches an acceleration object. FIG. 6 is a diagram showing an example of a game image when the player character is accelerated by contacting the acceleration object. In the example shown in FIG. 5 and FIG. 6, a player character 101 is running on a road object 102 arranged in the field, and an acceleration object 103 is arranged on the road object 102. Note that while the acceleration object 103 is arranged on the road object 102, acceleration objects may be arranged at any positions in the field.

An acceleration object is an object that has the function of accelerating a moving object. In the example shown in FIG. 6, the game system 1 accelerates the player character 101 in response to the player character 101 contacting the acceleration object 103. In the exemplary embodiment, the player character 101 is in an accelerated state during the acceleration period, i.e., until a predetermined amount of time elapses since when the player character 101 contacts the acceleration object 103. In the accelerated state, the player character 101 is controlled to gradually accelerate to reach a speed above the upper limit speed in the normal state (e.g., not in the accelerated state). Note that in the exemplary embodiment, the player character 101 being in the accelerated state is displayed with an effect image (an effect image of flame jetting backward in the example shown in FIG. 6) different from the normal state.

In the exemplary embodiment, the direction in which the player character 101 is accelerated by contacting the acceleration object 103 is calculated based on the front direction of the player character 101 (in cases where the player character is an object including a vehicle, the direction in which the front side of the vehicle is pointing). Specifically, in the exemplary embodiment, the acceleration direction of the player character 101 is the front direction. By calculating the direction in which the player character 101 is to be accelerated based on the front direction, it is easier for the player to predict the direction of acceleration. Note that the acceleration direction of the player character 101 does not need to coincide with the front direction, and may be calculated so that it is generally along the front direction. For example, a plurality of predetermined acceleration directions (e.g., four directions of front, rear, left, and right, relative to the acceleration object) may be set for the acceleration objects set on the field. In this case, one of the plurality of predetermined acceleration directions that is closest to the front direction at the time the player character 101 contacts the acceleration object 103 may be set as the acceleration direction of the player character 101.

In other embodiments, the acceleration direction of the player character 101 may be calculated based on the moving direction of the player character 101 (which may be different from the front direction when the player character is moving sideways), instead of the front direction of the player character 101. Note that when the player character 101 is running sideways, such as when drifting, for example, the moving direction of the player character 101 will be different from the front direction of the player character 101. In other embodiments, the acceleration direction of the player character 101 may be calculated based on both the front direction of the player character 101 and the moving direction of the player character 101. For example, the acceleration direction of the player character 101 may be calculated as a direction that is in the middle between the front direction of the player character 101 and the moving direction of the player character 101.

When the acceleration period ends, the accelerated state of the player character 101 is canceled and the player character 101 returns to the normal state. Then, the speed of the player character 101 changes to a speed that is less than or equal to the upper limit speed in the normal state.

As described above, the player character 101 can temporarily move at a higher speed than normal by contacting the acceleration object 103. Note that in the exemplary embodiment, other moving objects other than the player character 101 are also controlled to accelerate temporarily in response to contacting an acceleration object as is the player character 101.

The acceleration object 103 is displayed in a directional display style. Note that the directional display style may be any style of display where the direction of the object in the virtual space is suggested to the player. For example, in the example shown in FIG. 5 and FIG. 6, a plurality of arrows 104 pointing toward the far side as viewed from the virtual camera are displayed on the surface of the acceleration object 103, and the arrows 104 scroll toward the far side (see the dotted arrows in FIG. 5), so the acceleration object 103 suggests the direction toward the far side. In this example, the game system 1 renders the arrows 104 by mapping a texture including the arrows 104 on the acceleration object 103 so that the arrows 104 point toward the far side and so that the arrows 104 appears to move toward the far side over time. Note that the directional display style may be a style that suggests a direction to the player by means of at least one of the direction-indicating texture used to render the acceleration object 103 and the scroll direction of the texture. That is, the acceleration object 103 may be such that the pattern or design thereof suggests the direction thereof while the pattern or design does not change over time. Alternatively, the acceleration object 103 may be such that the pattern or design thereof does not suggest the direction thereof but scrolls in a certain direction over time to suggest the direction thereof. For example, the directional display style may be a style such that the direction thereof is suggested to the player by the outline shape of the acceleration object 103. For example, the acceleration object 103 may have an arrow-shaped outline.

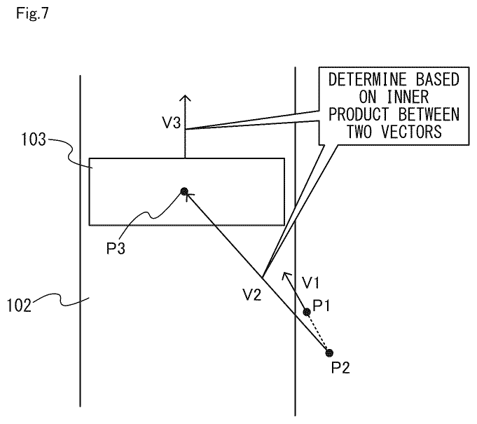

During the game, the direction indicated by the acceleration object 103 (hereinafter referred to as the “suggested direction”) changes depending on the line-of-sight direction of the virtual camera. FIG. 7 is a diagram showing an example of the method for setting the suggested direction of the acceleration object 103. FIG. 7 is a diagram of the field as viewed from above, and in the example shown in FIG. 7, the virtual camera is at the position P1, and the line-of-sight direction is the orientation of the vector V1. Note that although not shown in FIG. 7, the player character is located on the far side relative to the position P1 of the virtual camera in the line-of-sight direction V1 of the virtual camera.

In the exemplary embodiment, the game system 1 calculates the corrected position P2 based on the camera position P1 of the virtual camera. For example, the corrected position P2=(P2x, P2y, P2z) is calculated according to formula (1) below.

(P2x, P2y, P2z)=(P1x, P1y, P1z)−V1*(L+D)*S . . . (1)

In formula (1) above, (P1x, P1y, P1z) are the coordinates of the camera position P1. L is a predetermined fixed value based on the size of the acceleration object 103, and is half the length of the acceleration object 103 in the front-rear direction (in the exemplary embodiment, the direction parallel to the vector V3 to be described below), for example. D is a predetermined fixed value, and is set to a value (e.g., 2 m) about the same size as the player character 101, for example. S indicates the scale of the acceleration object 103. Note that in the exemplary embodiment, a basic acceleration object of a predetermined size is prepared, and acceleration objects that are enlarged or shrunk by the scale S from the basic acceleration object are arranged on the field. From formula (1) above, the corrected position P2 is a position that is obtained by moving the camera position P1 to the opposite side of the line-of-sight direction V1 by a distance in accordance with a coefficient that takes into account the size and scale of the acceleration object and the size of the player character. Note that the reason why three values of L, D, and S are used in formula (1) above will be explained later.

The game system 1 calculates the decision vector V2 based on the corrected position P2 and the position P3 of the acceleration object. The decision vector V2 is calculated as a vector with the corrected position P2 as its start point and the position P3 of the acceleration object as its end point. Note that it is assumed in the exemplary embodiment that the position P3 of the acceleration object is the center position of the acceleration object. On the acceleration object, the position to be the end point of the decision vector V2 is not limited to the center position, and may be any other position on the acceleration object.

The game system 1 sets the suggested direction based on the decision vector V2 and the object vector V3, which indicates the orientation of the acceleration object 103. In the exemplary embodiment, the suggested direction of the acceleration object 103 is set to be one of two directions: the first reference direction and the second reference direction, which is the opposite direction of the first reference direction. Note that in other embodiments, there may be three or more reference directions that the suggested direction can take. In the exemplary embodiment, the object vector V3 is oriented in the first reference direction of the acceleration object 103. Note that the first reference direction and the second reference direction of the acceleration object may be set in any way. For example, when an acceleration object is arranged on a road object, the acceleration object is set so that the first reference direction and the second reference direction are in the direction along which the road extends (see FIG. 7). For example, when an acceleration object is arranged on a race course in the first mode, the acceleration object is set so that the first reference direction is in the direction along the route of the race course and toward the goal point. Note that in other embodiments, when a plurality of specified acceleration directions are set on an acceleration object as described above, the first reference direction and the second reference direction may be set so that they are in the direction along one of the plurality of specified acceleration directions. The number of reference directions that the suggested direction can take and the number of specified acceleration directions may be the same, and the reference directions may coincide with the specified acceleration directions.

In the exemplary embodiment, one of the first reference direction and the second reference direction that is closer to the direction of the decision vector V2 is set as the suggested direction of the acceleration object 103. Specifically, the game system 1 calculates the inner product between the decision vector V2 and the object vector V3, and if the inner product is a positive value, the suggested direction of the acceleration object 103 is set to be the first reference direction, and if the inner product is a negative value, the suggested direction of the acceleration object 103 is set to be the second reference direction. In the example shown in FIG. 7, since the inner product between the decision vector V2 and the object vector V3 is a positive value, the suggested direction of the acceleration object 103 is set to be the first reference direction. Note that in other embodiments, where the suggested direction of the acceleration object is set to be one of three or more reference directions, one of the three or more reference directions that is closest to the decision vector V2 is set as the suggested direction of the acceleration object.

As described above, the suggested direction of the acceleration object is set to be the direction from the position of the virtual camera to the position of the acceleration object. Note that in the exemplary embodiment, the corrected position P2, rather than the camera position P1, is used for calculating the decision vector V2. This is because if the camera position P1 is used as the starting point of the decision vector, there is a risk that the direction of the decision vector will change significantly when the virtual camera passes over the acceleration object, causing the suggested direction to be inverted. For example, in the example shown in FIG. 7, where the camera position P1 passes over the position P3 of the acceleration object, the direction of the decision vector is inverted after the passing, resulting in the inversion of the suggested direction. Then, if the acceleration object is within the field of view of the virtual camera, there is a possibility that the suggested direction may appear to be inverted suddenly.

In contrast, in the exemplary embodiment, the decision vector is defined using the corrected position P2, which is located on the near side of the camera position P1 in the line-of-sight direction, instead of the camera position P1. That is, the starting point of the decision vector is corrected from the camera position P1 to the corrected position P2. Thus, it is possible to control so that the inversion of the suggested direction occurs after the virtual camera passes over the acceleration object (e.g., after the acceleration object has moved out of the field of view of the virtual camera), thereby reducing the possibility that the suggested direction may be displayed inverted. Therefore, the values of L, D, and S may be set so that, for example, the corrected position P2 is calculated as a position such that the amount of correction (e.g., the length from the camera position P1 to the corrected position P2) is longer than a half of the length (specifically, the length in the first reference direction) of the acceleration object 103. Note that in other embodiments, it is not necessary to use all three of these values in formula (1) above, and any one or two of the three values may be used for calculating the corrected position P2. For example, the amount of correction is adjusted by using L for adjusting the amount of correction in accordance with the size of the acceleration object, as well as in accordance with D based on the size of the player character in order to allow for more margin in the amount of correction in the exemplary embodiment, but only one of them may be used in formula (1) above in other embodiments. Moreover, in other embodiments, other coefficients may be used instead of at least one of the three values in formula (1) above.

Note that the method for calculating the decision vector is not limited to the above. For example, in other embodiments, the decision vector may be calculated as a vector with the camera position P1 as its start point and the position P3 of the acceleration object as its end point. Thus, as in the exemplary embodiment, the suggested direction of the acceleration object can be set to be the direction from the position of the virtual camera to the position of the acceleration object. For example, the game system 1 may use the line-of-sight direction V1 of the virtual camera as the decision vector. Thus, the suggested direction of the acceleration object can be set along the line-of-sight direction of the virtual camera. This also allows the suggested direction of the acceleration object to be changed dynamically as in the exemplary embodiment, and this allows the acceleration direction of the acceleration object to be displayed in a way that is easy for the player to understand.

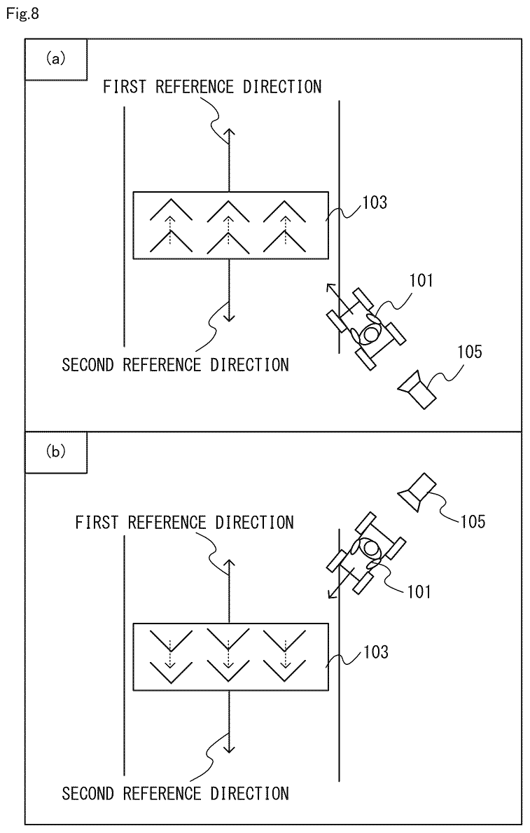

The game system 1 displays the acceleration object 103 so as to indicate the suggested direction that is set as described above. FIG. 8 is a diagram showing an example of the suggested direction of an acceleration object in a situation where the player character is approaching the acceleration object. (a) in FIG. 8 shows a situation in which the player character 101 approaches the acceleration object 103 from the lower side of the figure, and (b) in FIG. 8 shows a situation in which the player character 101 approaches the acceleration object 103 from the upper side of the figure. It is assumed in FIG. 8 that the first reference direction of the acceleration object 103 is the upward direction in the figure. In the situation shown in (a) of FIG. 8, as in the situation shown in FIG. 7, the decision vector is oriented in a direction that is close to the first reference direction, and as a result, the suggested direction of the acceleration object 103 is set to be the first reference direction, and the acceleration object 103 is displayed so as to indicate the first reference direction. On the other hand, in the situation shown in (b) of FIG. 8, the decision vector is oriented in a direction that is close to the second reference direction, and as a result, the suggested direction of the acceleration object 103 is set to be the second reference direction, and the acceleration object 103 is displayed so as to indicate the second reference direction. As described above, in the exemplary embodiment, the suggested direction of the acceleration object 103 changes in accordance with the line-of-sight direction of the virtual camera 105 relative to the acceleration object 103. In the exemplary embodiment, given that the virtual camera 105 moves to follow the player character 101 from behind, it can be said that the suggested direction changes depending on from which direction the player character 101 approaches the acceleration object 103.

Note that the suggested direction of the acceleration object does not need to coincide with the acceleration direction when the player character is accelerated in response to contacting the acceleration object. For example, if the player character 101 moves straight ahead and contacts the acceleration object 103 while facing diagonally to the first reference direction of the acceleration object 103, as in the situation shown in (a) of FIG. 8, the acceleration direction will be the front direction of the player character, e.g., a direction that is diagonal relative to the first reference direction as described above. Even if the suggested direction of the acceleration object does not exactly coincide with the acceleration direction of the player character, it can be said that the suggested direction suggests the acceleration direction of the player character. Therefore, the acceleration direction of the moving object can be displayed in a way that is easy for the player to understand.

Next, with regard to the operation of the virtual camera, the method for setting the suggested direction when a reverse operation input described above is performed will be described. FIG. 9 is a diagram showing an example of a game image in a situation where there is a reverse operation input by the player. In a situation where there is a reverse operation input, as shown in FIG. 9, the virtual camera is arranged facing the player character 101 at a position in front of the player character 101. Note that the game system 1 moves the player character 101 backward in response to a predetermined operation input by the player. For example, in the situation shown in FIG. 9, the acceleration object 103 is arranged behind the player character 101, so if the player character 101 moves backwards from this situation, the player character 101 will run into and contact the acceleration object 103 from the rear side thereof.

Even when the player character 101 runs into and contacts the acceleration object 103 from the rear side thereof as described above, the player character 101 is controlled to be in the accelerated state as when the player character 101 runs into and contacts the acceleration object 103 from the front side thereof. That is, the player character 101 is controlled to accelerate in the front direction of the player character 101. Therefore, if the player character 101 moves backward from the situation shown in FIG. 9 and contacts the acceleration object 103, the player character 101 will accelerate and move toward the near side as viewed by the virtual camera.

Here, in the situation shown in FIG. 9, if the suggested direction of the acceleration object 103 is set using the method shown in FIG. 7, the suggested direction will be the direction toward the far side relative to the virtual camera. However, if the player character 101 contacts the acceleration object 103 in this situation, the player character 101 will accelerate and move toward the near side as described above. Therefore, in this situation, if the suggested direction of the acceleration object 103 is set using the method shown in FIG. 7, the suggested direction of the acceleration object 103 will not be along the acceleration direction of the player character 101.

Therefore, in the exemplary embodiment, during the period in which there is a reverse operation input by the player, the game system 1 sets the suggested direction to be along the opposite direction from the line of sight of the virtual camera. Specifically, during this period, the game system 1 sets the suggested direction to be a direction that is obtained by inverting the direction set using the method shown in FIG. 7. Accordingly, in the example shown in FIG. 9, the acceleration object 103 is displayed so as to indicate a direction toward the near side relative to the virtual camera (see FIG. 9). As a result, the suggested direction of the acceleration object 103 can be set to be the direction in which the player character 101 is accelerated when the player character 101 contacts the acceleration object 103.

As described above, in the exemplary embodiment, the player can have a game image displayed that shows a view behind the player character, and also in that case, the suggested direction of the acceleration object can be set to be a direction along the acceleration direction of the player character 101.

In the exemplary embodiment, the game system 1 executes the process of setting the suggested direction of the acceleration object described above both in the first mode and in the second mode. Since a race course is set in the first mode, the player basically performs an operation so as to move the player character along the race course. Therefore, in the first mode, the line-of-sight direction of the virtual camera is likely to be a direction along the race course. Here, since the suggested direction is automatically set in accordance with the line-of-sight direction of the virtual camera as described above in the exemplary embodiment, the suggested direction of the acceleration object will automatically be a direction along the race course if the line-of-sight direction of the virtual camera is a direction along the race course in the first mode. Therefore, in the exemplary embodiment, there is no need for the developer to manually set the suggested direction of the acceleration object to be a direction along the race course set in the field, and the suggested direction can be set to be a direction along the race course without such setting.

For example, the acceleration object is set so that the first reference direction and the second reference direction are in the direction along the road on the race course. In this case, the suggested direction of the acceleration object is one of the forward direction and the reverse direction along the road on the race course that is closer to the line-of-sight direction of the virtual camera. Accordingly, since the suggested direction of the acceleration object is a direction along the race course, it is possible to suggest to the player the direction in which the player character is supposed to travel in the race in a way that is easy for the player to understand. With the suggested direction of the acceleration object, it is possible to suggest the direction in which the route of the race course extends.

In the second mode, since the player can freely move the player character on the field, the line-of-sight direction of the virtual camera may also change variously. In the exemplary embodiment, as described above, the suggested direction of the acceleration object changes in accordance with the line-of-sight direction of the virtual camera relative to the acceleration object. Therefore, since the player recognizes that the suggested direction of the acceleration object changes dynamically during the game in the second mode, the exemplary embodiment allows the player to recognize that the acceleration direction of the acceleration object is not fixed. The general acceleration direction of the acceleration object can be suggested to the player by the suggested direction.

### 3. Specific Example Process in Game System

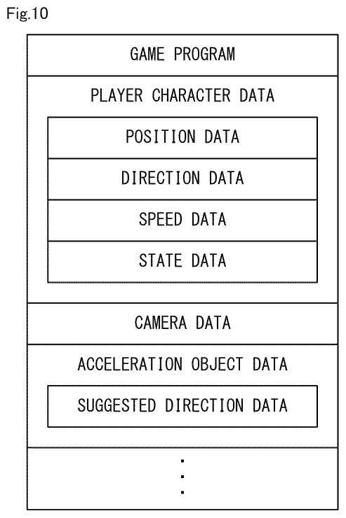

Next, referring to FIG. 10 to FIG. 12, a specific example of an information process in the game system 1 will be described. FIG. 10 is a diagram showing an example of a storage area that stores various data used in information processes in the game system 1. Each of the data shown in FIG. 10 is stored in a storage medium that can be accessed by the main body apparatus 2 (e.g., the flash memory 26, the DRAM 27, and/or a memory card inserted in the slot 29, etc.).

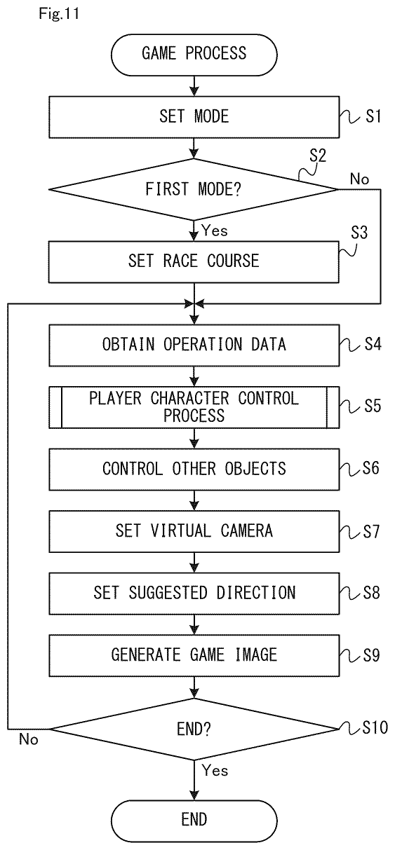

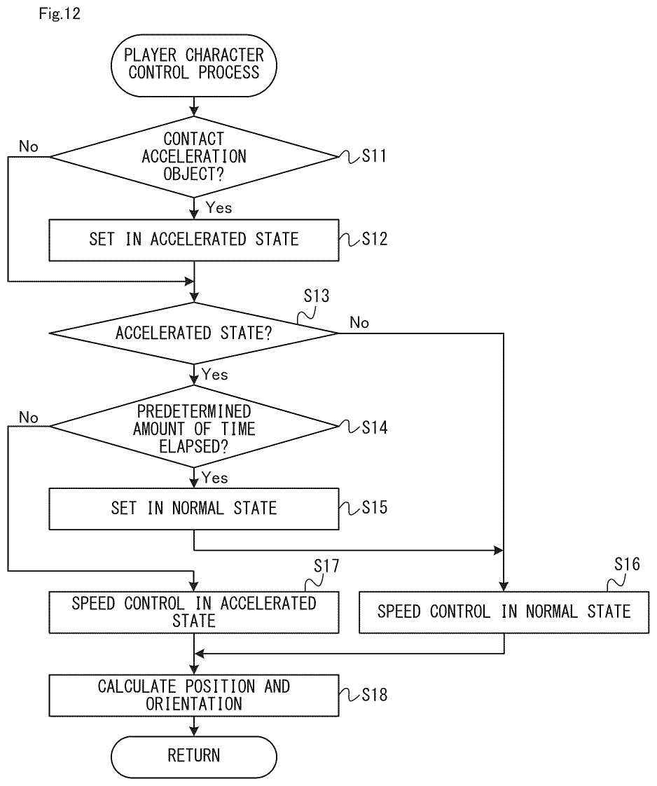

As shown in FIG. 10, the game system 1 stores a game program. The game program is a program for executing the game processes (the processes shown in FIG. 11 and FIG. 12) that are executed by the main body apparatus 2. As the processor 21 of the main body apparatus 2 executes the game program, the processes to be described below will be executed in the game system 1.

As shown in FIG. 10, the game system 1 stores player character data, camera data, and acceleration object data. Note that in addition to these data, the game system 1 may also store data related to objects that appear in the field (e.g., moving objects that participate in the race game in the first mode). Note that at the start of the game, the data mentioned above are set to contents that indicate the initial state.

The player character data indicates information related to the player character. In the exemplary embodiment, the player character data includes position data, direction data, speed data, and state data. The position data indicates the position of the player character in the field. The direction data indicates the orientation (or “attitude”) of the player character in the field. The speed data indicates the current speed of the player character. The state data indicates whether the player character is in the normal state or the accelerated state. Note that in addition to the data mentioned above, the player character data may also include, for example, data for items that the player character can use.

The camera data indicates information related to the virtual camera. For example, the camera data includes data indicating the position, direction, viewing angle, etc., of the virtual camera.

The acceleration object data indicates information related to acceleration objects. The acceleration object data is stored for each acceleration object arranged on the field. In the exemplary embodiment, acceleration object data includes suggestion direction data indicating the suggestion direction. Note that the game system 1 stores, as data related to acceleration objects, data indicating the positions of acceleration objects arranged on the field, and data indicating the scale described above, etc. These data may be included in the game program.

FIG. 11 is a flowchart showing an example of the flow of the game process executed by the game system 1. The execution of the game process is started, for example, in response to an instruction by the player to start the game during execution of the game program.

Note that the exemplary embodiment will be described assuming that the processor 21 of the main body apparatus 2 executes the game program stored in the game system 1 to execute the processes of the steps shown in FIG. 11 and FIG. 12. Note that if the game system 1 is capable of communicating with another information processing device (e.g., a server), some of the processes of the steps shown in FIG. 11 and FIG. 12 may be executed on the other information processing device. The processes of the steps shown in FIG. 11 and FIG. 12 are merely illustrative, and the order of steps to be performed may be switched around or other processes may be executed in addition to (or instead of) the processes of the steps, as long as similar results are obtained.

The processor 21 executes the processes of the steps shown in FIG. 11 and FIG. 12 using a memory (e.g., the DRAM 27 or memory provided on SoC). The processor 21 stores the information (in other words, data) obtained by each processing step in the memory and reads out the information from the memory to use the information in a subsequent process step.

In step S1 shown in FIG. 11, the processor 21 sets the mode of the game to be executed to a mode selected from among the first mode and the second mode. While the method of setting the mode is arbitrary, the processor 21, for example, accepts an operation input to select a mode and sets the mode selected by the player as the mode of the game to be executed. The process of step S2 is executed, following step S1.

In step S2, the processor 21 determines whether the mode to be executed is the first mode. If the determination result from step S2 is affirmative, the process of step S3 is executed. On the other hand, if the determination result from step S2 is negative, the process of step S4 is executed.

In step S3, the processor 21 sets a race course to be used in the race game in the first mode. Specifically, the processor 21 sets the movement range described above in the field, and sets the race course in the movement range. Note that one race course is selected by a predetermined method from among race courses provided in advance in the game program. While the method for selecting a race course is arbitrary, a race course may be selected by the player, or if race games are played consecutively, the race course for the latter race game may be selected based on the race course for the previous race game, for example. The process of step S4 is executed, following step S3.

In the first mode, the game is started after the movement range in which the player character can move is set by the processing of step S3, and the processes of steps S4 to S10 to be described below are executed. On the other hand, in the second mode, since the processing of step S3 is not executed, the game is started without setting the movement range, and the processes of steps S4 to S10 are executed.

In step S4, the processor 21 obtains the operation data representing an operation input by the player. Specifically, the processor 21 obtains the operation data received from the controllers via a controller communication section 83 and/or terminals 17 and 21. The process of step S5 is executed, following step S4.

In step S5, the processor 21 executes the player character control process for controlling the player character. In the player character control process, the movement of the player character is controlled based on the operation input by the player. Referring now to FIG. 12, the details of the player character control process of step S5 will be described.

FIG. 12 is a sub-flowchart showing an example of the detailed flow of the player character control process of step S5 shown in FIG. 11. In the player character control process, first, in step S11, the processor 21 determines whether the player character has contacted an acceleration object. The decision process of step S11 is performed based on the position data of the player character data and data representing the position of the acceleration object stored in the memory. The specific decision method of step S11 is arbitrary. For example, the processor 21 may perform the contact decision by using the contact decision area set for the player character and the contact decision area set for the acceleration object. Alternatively, for example, the processor 21 may perform the decision process based on whether the position of the player character represented by the position data is included within the area on the acceleration object. If the determination result from step S11 is affirmative, the process of step S12 is executed. On the other hand, if the determination result from step S11 is negative, the process of step S13 is executed.

In step S12, the processor 21 sets the player character to the accelerated state. Specifically, the processor 21 updates the state data stored in the memory to contents that indicate the accelerated state. Note that it is assumed that at the start of the game process, the state data indicating the normal state is stored in the memory. Note that if the player character has already been set to the accelerated state at the point in time of step S12, the state data is not updated, and the accelerated state of the player character is maintained. If the player character is changed from the normal state to the accelerated state in the process of step S12, the processor 21 starts counting the elapsed time since the player character is set to the accelerated state. The process of step S13 is executed, following step S12.

In step S13, the processor 21 determines whether the player character is in the accelerated state. The decision process of step S13 is performed based on the state data of the player character data stored in the memory. If the determination result from step S13 is affirmative, the process of step S14 is executed. On the other hand, if the determination result from step S13 is negative, the process of step S16 to be described below is executed.

In step S14, the processor 21 determines whether the elapsed time since when the player character is set to the accelerated state has exceeded a predetermined amount of time. If the determination result from step S14 is affirmative, the process of step S15 is executed. On the other hand, if the determination result from step S14 is negative, the process of step S17 to be described below is executed.

In step S15, the processor 21 sets the player character to the normal state. Specifically, the processor 21 updates the state data stored in the memory to contents that indicate the normal state. The process of step S16 is executed, following step S15.

In step S16, the processor 21 performs the speed control in the normal state for the player character. This speed control is performed based on the operation data obtained in step S1. Specifically, if an acceleration operation input is performed by the player for the player character, the current speed of the player character is increased with the upper limit being the upper limit speed in the normal state. If a deceleration operation input is performed by the player, the current speed of the player character is decreased. If neither the acceleration operation input nor the deceleration operation input is performed, the current speed of the player character is decreased by a decrement that is less than that used when the deceleration operation input is performed. Note that in step S16, the processor 21 updates the speed data stored in the memory to contents indicating the speed that is obtained as described above. The process of step S18 is executed, following step S16.

In step S17, the processor 21 performs the speed control in the accelerated state for the player character. Specifically, the speed of the player character is calculated so as to increase the current speed by a predetermined amount or by a predetermined ratio. Note that in step S16, the processor 21 updates the speed data stored in the memory to contents indicating the speed calculated as described above. The process of step S18 is executed, following step S17.

In step S18, the processor 21 calculates the position and orientation of the player character. As a result, the player character moves to the calculated position and takes the calculated orientation. The position and orientation are calculated based on the position data and direction data stored in the memory (e.g., the current position and orientation of the player character), the speed calculated in the process of step S16 or S17, and the operation data obtained in step S1 (specifically, the direction input to change the moving direction of the player character). For example, the processor 21 sets the new position of the player character as a position that is obtained by moving the current position of the player character by a distance in accordance with the speed in an orientation that is obtained by changing the current orientation of the player character in accordance with the direction input. The processor 21 sets the new orientation of the player character as an orientation that is obtained by changing the current orientation of the player character in accordance with the direction input. The processor 21 updates the position data and the direction data stored in the memory so that they represent the new position and the new orientation. After step S18, the processor 21 ends the player character control process.

Referring back to FIG. 11, in step S6, following step S5, the processor 21 controls the objects other than the player character. For example, the other objects are controlled based on a rule predetermined in the game program. Note that in the first mode, the moving objects participating in the race game are controlled so that the moving objects are accelerated when contacting acceleration objects, as is the player character. If moving objects other than the player character participate in the second mode, the other moving objects may also be controlled so that the moving objects are accelerated when contacting acceleration objects. The process of step S7 is executed, following step S6.

In step S7, the processor 21 performs the setting of the virtual camera. As described above, when there is no operation input for the virtual camera, the position and orientation of the virtual camera are calculated so that the virtual camera follows the player character from behind. When the camera operation input is performed, the position and orientation of the virtual camera are calculated so that the virtual camera revolves in accordance with the input while maintaining its line-of-sight direction facing the player character. When the reverse operation input is performed, the position and orientation of the virtual camera are calculated so that the virtual camera is in the position and orientation as the player character is viewed from the front. The processor 21 updates the camera data stored in the memory so as to represent the contents calculated as described above. The process of step S8 is executed, following step S7.

In step S8, the processor 21 sets the suggested direction of the acceleration object. Specifically, based on the position and orientation of the virtual camera set in step S7, the suggested direction is set according to the method described in [2. Game example in game system] above. Note that if a plurality of acceleration objects are arranged on the field, the processor 21 sets the suggested direction for each of the acceleration objects in the process of step S8. Note however that in the process of step S8, the processor 21 does not need to set the suggested direction for all of the acceleration objects on the field. For example, the suggested direction may be set for those acceleration objects to be rendered from among all the acceleration objects on the field (e.g., those acceleration objects that are located within the field of view of the virtual camera and located within a predetermined distance from the virtual camera). The processor 21 updates the suggested direction data stored in the memory so as to represent the suggested direction that has been set. The process of step S9 is executed, following step S8.

In step S9, the processor 21 generates and displays the game image on a display device. Specifically, based on the virtual camera set in step S8, the processor 21 renders, in the frame buffer, the game image that represents the field as viewed from the position of the virtual camera in the orientation of the virtual camera. Here, regarding the rendering of an acceleration object, a texture is mapped on the acceleration object so that the acceleration object appears to suggest the suggested direction that is set in step S8 for the acceleration object. The game image is displayed on the display device as the game image rendered in the frame buffer is output to the display device. Note that the display device to which the game image is output may be the display 12 of the main body apparatus 2 or another monitor separate from the display 12 connected to the main body apparatus 2. In the exemplary embodiment, the loop of a series of processes of steps S4 to S10, including step S9, is repeatedly executed at a cycle of once per a predetermined amount of time. Thus, the game image to be displayed is updated at a rate of once per one frame time. The process of step S10 is executed, following step S9.

In step S10, the processor 21 determines whether to end the game process. For example, the processor 21 determines to end the game when a predetermined operation input to end the game is performed by the player, or when a condition to end the game (e.g., the game be cleared or the game be over) is satisfied. If the determination result from step S10 is negative, the process of step S4 is executed again. Thereafter, a series of processes of steps S4 to S10 is repeatedly executed until it is determined to end the game in step S10. On the other hand, if the determination result from step S10 is affirmative, the processor 21 ends the game process shown in FIG. 11.

### 4. Functions/Effects and Variations of Exemplary Embodiment

As described above, in the embodiment described above, the acceleration direction of an acceleration object can be displayed in a way that is easy for the player to understand by setting the suggested direction of the acceleration object to a direction toward the acceleration object from the virtual camera or to a direction along the line-of-sight direction of the virtual camera. In the exemplary embodiment, by changing the suggested direction in accordance with the positional relationship between the acceleration object and the virtual camera, it is possible to suggest to the player that by acceleration object can give acceleration in various directions. For example, in the exemplary embodiment, at a point in time before the player character contacts the acceleration object, the player can be notified of the direction in which the player character is accelerated if the player character continues to move forward to contact the acceleration object.

While the game system 1 can execute the game in the first mode and the game in the second mode in the embodiment described above, the game system 1 may be able to execute only the game in one mode in other embodiments. The game system 1 may execute any type of game in which the player character moves around a field, not limited to race games.

Note that, in the embodiment described above, where a process is executed using data and/or a program in an information processing apparatus, a part of the data and/or program necessary for the process may be transmitted from another information processing apparatus different from said information processing apparatus. Then, the first information processing apparatus may execute the process using data and/or a program received from the second information processing apparatus and data and/or a program stored in the first information processing apparatus.

Note that in other embodiments, the information processing system does not need to include some of the components of the embodiment described above and does not need to execute some of the processes that are executed in the embodiment described above. For example, in order to realize a certain process result in the embodiment described above, the information processing system may include a component or components for realizing said process result and execute a process or processes for realizing said process result, and the information processing system does not need to include other components and does not need to execute other processes.

The embodiment described above can be used as a game system or a game program, for example, with the aim of displaying the acceleration direction of an acceleration object in a way that is easy for the player to understand, for example.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing, the information processing comprising:
controlling a player character to move on a field in a virtual space based on an operation input;
controlling a virtual camera to move in the virtual space so as to include the player character in a field of view thereof and to follow the player character from behind;
setting a first direction for a first object, which is arranged on the field and displayed in a directional display style that is directional in the first direction, wherein the first direction is set in a direction along a direction from the virtual camera to the first object or in a direction along a line-of-sight direction of the virtual camera; and
in response to contact between the first object and the player character, accelerating the player character in a second direction that is along a front direction of the player character.

2. The non-transitory computer-readable storage medium according to claim 1, the information processing further comprising:
in a first mode,
setting a movement range along a predetermined route on the field; and
moving a plurality of characters, including the player character, in the movement range to thereby realize a race between the plurality of characters.

3. The non-transitory computer-readable storage medium according to claim 2, wherein:
the route is along a road object arranged on the field; and
the information processing comprises:
for the first object arranged on the road object, setting, as the first direction, one of a forward direction and a reverse direction along a road that is closer to the line-of-sight direction of the virtual camera.

4. The non-transitory computer-readable storage medium according to claim 3, the information processing further comprising:
in a second mode,
controlling the player character to move without setting the movement range along the route.

5. The non-transitory computer-readable storage medium according to claim 1, the information processing further comprising:
in a predetermined period of time specified based on an operation input,
arranging the virtual camera at a position in front of the player character in a direction facing the player character; and
setting the first direction in a direction along an opposite direction from a line of sight of the virtual camera.

6. The non-transitory computer-readable storage medium according to claim 1, wherein the directional display style is based on at least one of an orientation of a texture used in rendering the first object and a scroll direction of the texture.

7. An information processing system comprising one or more processors that execute information processing, the information processing comprising:
controlling a player character to move on a field in a virtual space based on an operation input;
controlling a virtual camera to move in the virtual space so as to include the player character in a field of view thereof and to follow the player character from behind;
setting a first direction for a first object, which is arranged on the field and displayed in a directional display style that is directional in the first direction, wherein the first direction is set in a direction along a direction from the virtual camera to the first object or in a direction along a line-of-sight direction of the virtual camera; and
in response to contact between the first object and the player character, accelerating the player character in a second direction that is along a front direction of the player character.

8. The information processing system according to claim 7, the information processing further comprising:
in a first mode,
setting a movement range along a predetermined route on the field; and
moving a plurality of characters, including the player character, in the movement range to thereby realize a race between the plurality of characters.

9. The information processing system according to claim 8, wherein:
the route is along a road object arranged on the field; and
the information processing comprises:
for the first object arranged on the road object, setting, as the first direction, one of a forward direction and a reverse direction along a road that is closer to the line-of-sight direction of the virtual camera.

10. The information processing system according to claim 9, the information processing further comprising:
in a second mode,
controlling the player character to move without setting the movement range along the route.

11. The information processing system according to claim 7, the information processing further comprising:
in a predetermined period of time specified based on an operation input,
arranging the virtual camera at a position in front of the player character in a direction facing the player character; and
setting the first direction in a direction along an opposite direction from a line of sight of the virtual camera.

12. The information processing system according to claim 7, wherein the directional display style is based on at least one of an orientation of a texture used in rendering the first object and a scroll direction of the texture.

13. An information processing apparatus comprising one or more processors that execute information processing, the information processing comprising:
controlling a player character to move on a field in a virtual space based on an operation input;
controlling a virtual camera to move in the virtual space so as to include the player character in a field of view thereof and to follow the player character from behind;
setting a first direction for a first object, which is arranged on the field and displayed in a directional display style that is directional in the first direction, wherein the first direction is set in a direction along a direction from the virtual camera to the first object or in a direction along a line-of-sight direction of the virtual camera; and
in response to contact between the first object and the player character, accelerating the player character in a second direction that is along a front direction of the player character.

14. The information processing apparatus according to claim 13, the information processing further comprising:
in a first mode,
setting a movement range along a predetermined route on the field; and
moving a plurality of characters, including the player character, in the movement range to thereby realize a race between the plurality of characters.

15. The information processing apparatus according to claim 14, wherein:
the route is along a road object arranged on the field; and
the information processing comprises:
for the first object arranged on the road object, setting, as the first direction, one of a forward direction and a reverse direction along a road that is closer to the line-of-sight direction of the virtual camera.

16. The information processing apparatus according to claim 15, the information processing further comprising:
in a second mode,
controlling the player character to move without setting the movement range along the route.

17. The information processing apparatus according to claim 13, the information processing further comprising:
in a predetermined period of time specified based on an operation input,
arranging the virtual camera at a position in front of the player character in a direction facing the player character; and
setting the first direction in a direction along an opposite direction from a line of sight of the virtual camera.

18. The information processing apparatus according to claim 13, wherein the directional display style is based on at least one of an orientation of a texture used in rendering the first object and a scroll direction of the texture.

19. A game processing method performed on an information processing system, the game processing method comprising:
controlling a player character to move on a field in a virtual space based on an operation input;
controlling a virtual camera to move in the virtual space so as to include the player character in a field of view thereof and to follow the player character from behind;
setting a first direction for a first object, which is arranged on the field and displayed in a directional display style that is directional in the first direction, wherein the first direction is set in a direction along a direction from the virtual camera to the first object or in a direction along a line-of-sight direction of the virtual camera; and
in response to contact between the first object and the player character, accelerating the player character in a second direction that is along a front direction of the player character.

20. The game processing method according to claim 19, further comprising:
in a first mode,
setting a movement range along a predetermined route on the field; and
moving a plurality of characters, including the player character, in the movement range to thereby realize a race between the plurality of characters.

21. The game processing method according to claim 20, wherein:
the route is along a road object arranged on the field; and
the game processing method further comprising:
for the first object arranged on the road object, setting, as the first direction, one of a forward direction and a reverse direction along a road that is closer to the line-of-sight direction of the virtual camera.

22. The game processing method according to claim 21, further comprising:
in a second mode,
controlling the player character to move without setting the movement range along the route.

23. The game processing method according to claim 19, further comprising:
in a predetermined period of time specified based on an operation input,
arranging the virtual camera at a position in front of the player character in a direction facing the player character; and
setting the first direction in a direction along an opposite direction from a line of sight of the virtual camera.

24. The game processing method according to claim 19, wherein the directional display style is based on at least one of an orientation of a texture used in rendering the first object and a scroll direction of the texture.
